(19) United States
(12) Patent Application Publication
(10) Pub. No.: US 2006/0121762 A1
(43) Pub. Date: Jun. 8, 2006

(54) Elbow-shaped electric plug

(76) Inventors: Armin Reicharz, Apples (CH); Michel Ritter, Apples (CH)

Correspondence Address: NIXON & VANDERHYE, PC, 901 NORTH GLEBE ROAD, 11TH FLOOR, ARLINGTON, VA, 22203, US

(21) Appl. No.: 10/539,416

(22) PCT Filed: Dec. 17, 2003
(86) PCT No.: PCT/CH03/00824

§ 371 Date: Jun. 17, 2005

(30) Foreign Application Priority Data
Jan. 8, 2003 (CH) 18/03

(51) Int. Cl. H01R 13/52

(52) U.S. Cl. 439/275

(57) ABSTRACT

The inventive elbow-shaped electric plug comprises first (7) and second (6) cylindrical hollow bodies which are fixed to each other and form an angle. The end (2) of the first body (7) closed by a plug (3) is arranged on the end (1) of the second body (6), thereby defining a continuous channel between the free ends (8, 12) of two bodies (6, 7). The first body (7) comprises a demountable contact unit (5, 11). Said electric plug also comprises a cylindrical coaxial cage (4) arranged in the first body (7) in such a way that it maintains in the position the demountable contact unit (5, 11). The cage (4) is also provided with a recess (23) embodied on the longitudinal wall thereof and disposed on the side of the free end (12) of the second cylindrical body (6).

### FIELD OF THE INVENTION

The present invention falls within the field of elbow-shaped electric plugs. It relates more particularly to small-sized elbow-shaped plugs.

### STATE OF THE ART

Numerous types of elbow-shaped plugs are known.

By way of example, mention may be made of those described in patent documents U.S. Pat. No. 4,128,292, WO 94/02976, U.S. Pat. No. 4,480,887.

One type of elbow-shaped plug comprises first and second hollow cylindrical bodies fixed at right angles to one another, one end of the first body being housed in one end of the second body so as to define a continuous passage between the free ends of the two bodies.

Elbow-shaped plugs are generally used when the space considerations do not allow the use of a straight plug or when the destination of the cable is in a direction too far removed from the main axis of the plug. As a side issue, the elbow shape makes it possible to reduce the stress exerted on the plug because the moment caused by tension on the cable is smaller.

The elbow-shaped plugs of the state of the art do, however, have a certain number of disadvantages:
They are complex components, which means that assembly is complicated.
They are expensive components, mainly on account of their complexity.
They do not seal perfectly.
There are difficulties in connecting the cable.

### SUMMARY OF THE INVENTION

The present invention is aimed in particular at solving the aforementioned problems.

It relates to an elbow-shaped electric plug as defined in the main claim.

The invention also relates to a cylindrical cage as defined in claim 14.

The invention will be better understood from reading the detailed description which will follow and from examining the attached figures which, by way of nonlimiting example, depict two embodiments of the invention.

### BRIEF DESCRIPTION OF THE DRAWINGS

FIG. 1 shows an elbow-shaped plug according to the invention (1A, compact view, 1B, exploded view).

FIG. 2 illustrates a lateral section through a first embodiment of an elbow-shaped plug according to the invention.

FIG. 3 shows a cylindrical cage used in the plug of FIG. 2.

FIG. 4 shows a frontal view of the cylindrical cage of FIG. 3.

FIG. 5 shows a lateral view of the cylindrical cage of FIG. 3.

FIG. 6 illustrates a lateral section of a second embodiment of an elbow-shaped plug according to the invention.

FIG. 7 shows a cylindrical cage used in the plug of FIG. 5 (viewed from above).

FIG. 8 shows a cylindrical cage used in the plug of FIG. 5 (viewed from beneath).

FIG. 9 shows a lateral view of the cylindrical cage of FIG. 5.

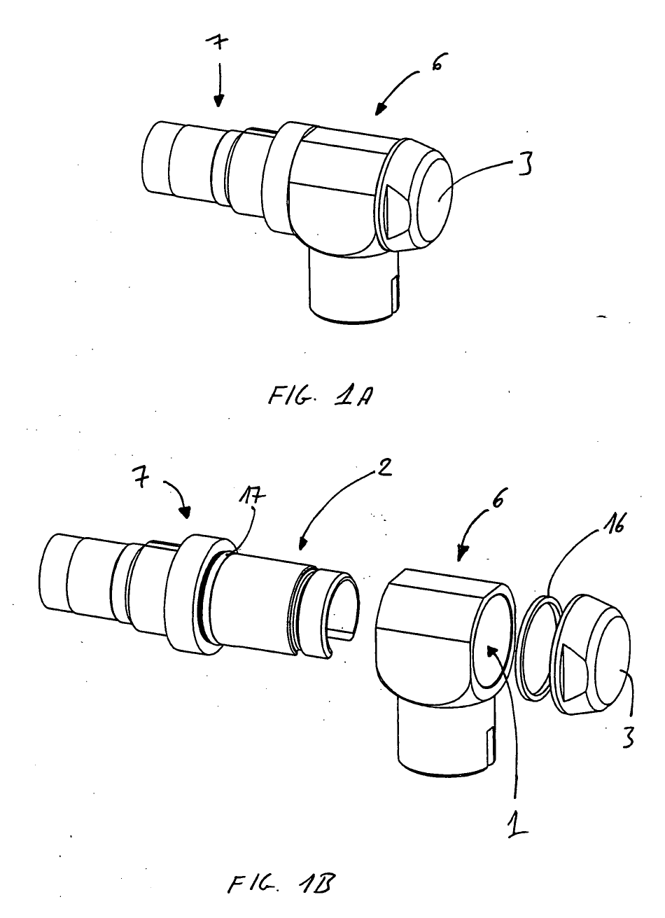

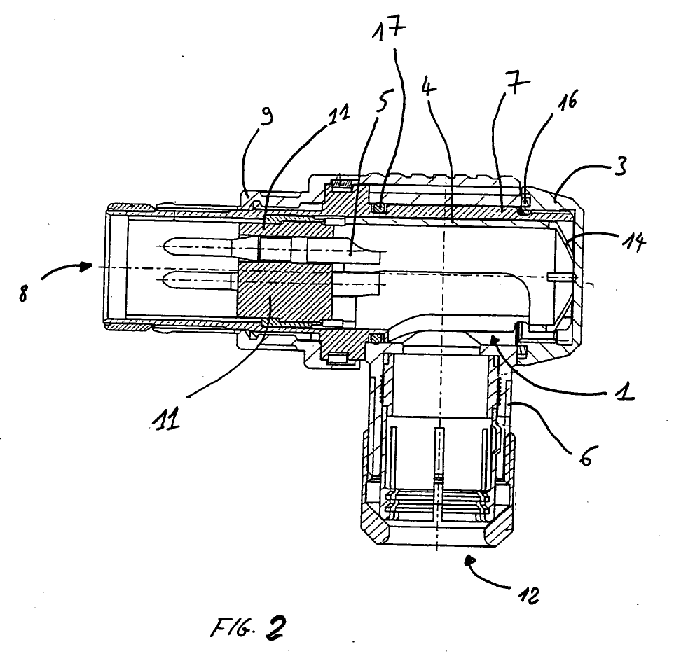

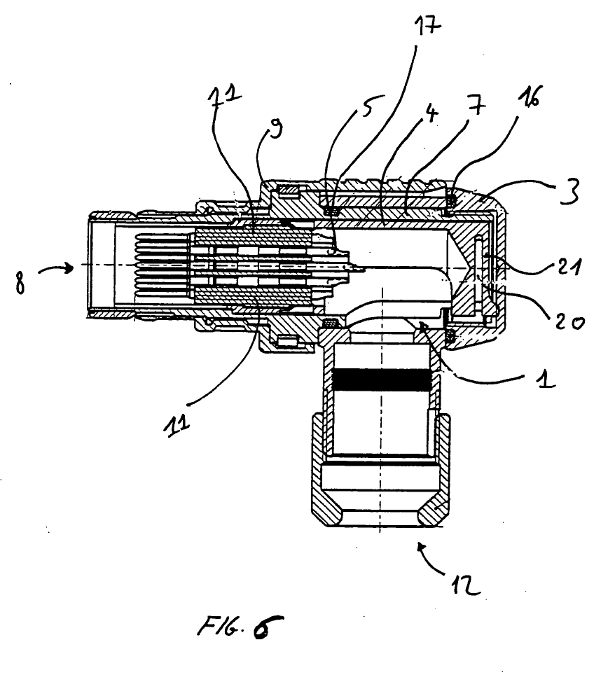

The elbow-shaped plug illustrated in FIG. 1 comprises a first hollow cylindrical body 7 housed in the end of a second hollow cylindrical body 6. One end of the first body 7 is closed by a stopper 3. The inside of the first body 7 (refer to the two variants illustrated in FIGS. 2 and 6) comprises electrical contacts 5 fixed in an insulator 11. A collection of conducting wires (not illustrated in order to make the invention easier to interpret) connected to the electrical contacts 5 is arranged inside the second body 6. The assembly consisting of the connected two ends of the body 6, 7 is surrounded by an optional spring sleeve 9, required for locking connectors of the “push/pull” type.

The end of the first body 7 which end is housed in the second body 6, is surrounded by a seal of the O-ring type 16.

A second seal of the O-ring type 17 is situated between the first body 7 and the second body 6, inside the second body 6 so as also to ensure optimum electrical contact between the bodies 6, 7.

One of the conventional problems with elbow-shaped connectors stems from the fact that the contact block, essentially consisting of the electrical contacts 5 and the insulator 11, has to be removable so as to allow the cable to be fixed to the contacts prior to the insertion of this block in the housing.

It is then necessary to hold this block in place using a rigid piece pressing at the front on the block and butting against the closure stopper 3. Unless it is held firmly, the block could move during manipulation, and the electrical contact would then be poor.

Since assembling such a connector involves numerous complex components, the result is that the longitudinal space available for the cage within the body is subject to a large tolerance range. In conventional designs that leads to a functional problem because the rigid component is undersized in terms of length in order to compensate for these tolerances, but then the block is not correctly held, or alternatively the rigid component is oversized in order to ensure that the block is held firmly, but then the stopper does not close sufficiently at the seal.

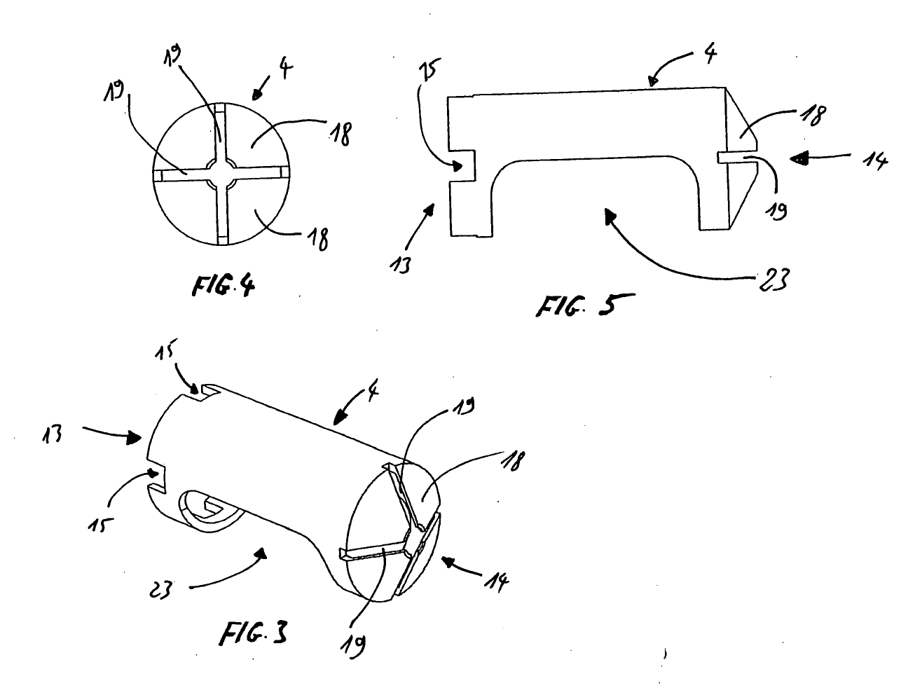

The variant illustrated in FIGS. 2 to 5 uses a cage 4 having an elastic part at the rear in the form of a split cone 18, 19. The cage 4 further comprises a hollowing 23 formed on its longitudinal wall and arranged on the same side as the free end of the second cylindrical body. The width of the hollowing 23 preferably extends over about 180° around the main axis of the cage.

The dimensions, positions, shapes and number of slots 19 may be tailored to suit the size and shape of the connector so as to perform its function in the optimum way.

Advantageously, the cage 4 may be oversized to ensure that the contact block is held firmly while at the same time, through the flexing of the parts that form the cone 18, allowing the stopper 3 to close completely and clamping the seal 13 situated between the two body elements 6, 7.

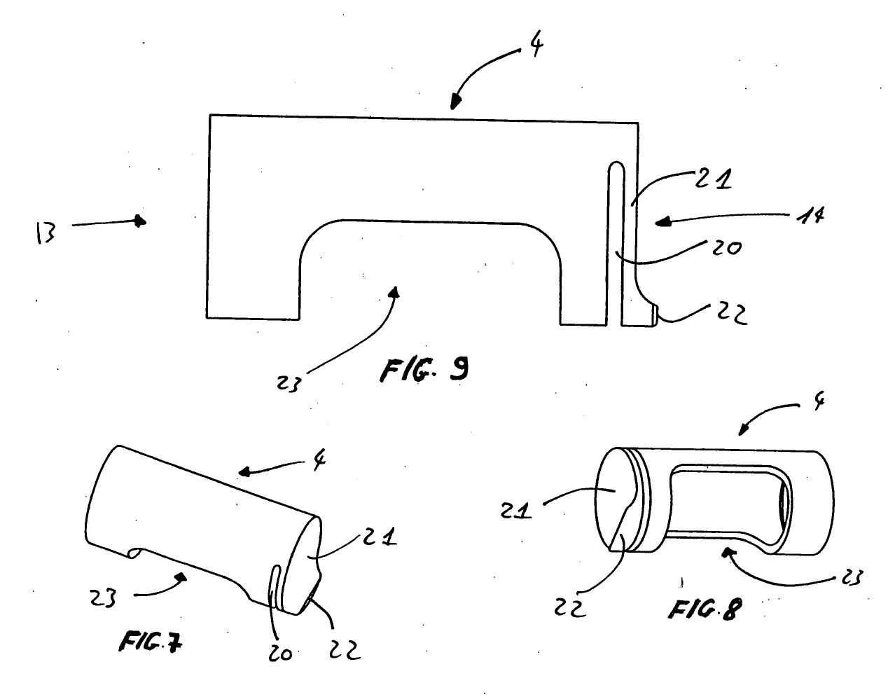

The variant illustrated in FIGS. 6 to 9 has exactly the same function as the aforementioned variant. It differs from the latter in that the elastic part of the cage 4 is produced by means of a slot 20 perpendicular to its axis, this slot 20 is situated near the end of the cage 4 in contact with the stopper 3. The end of the cage 4 being closed and forming a disk 21. The elasticity may be chosen to suit the thickness of the disk 21 and the size of the slot 20. The disk 21 has a protrusion 22 to ensure elastic mechanical contact and a well-controlled return force irrespective of the tolerances on the components of the housing. The height of the protrusion 22 and the width of the slot 20 are determined according to the clearance that needs to be compensated.

This variant offers the advantage of obtaining elasticity which is controlled through the size and position of the slot, and the result can be mastered with ease.

According to one embodiment of the preceding two variants (see FIGS. 3 and 5) the cage comprises several slots 15, for example four slots 90° apart, arranged along its length. These slots 15 are intended to accept protrusions that form part of the insulator 11, thus ensuring that the cage 4 is correctly orientated, and in this way guaranteeing that the hollowing 23 will be kept in the right position for the passage of the cables.

Another embodiment of the invention, not illustrated, consists in a cage, for example with an unslotted conical part. As a preference, the cage is significantly undersized with respect to the housing in the first cylindrical body 7. The space between the cage 4 and the stopper 3 is compensated for by an elastic component, for example one made of elastomer or consisting of a metal spring. The function thus performed is the same as that obtained with the cage depicted in FIGS. 2 and 6.

The cage according to the invention may be produced in various ways, for example in machined or pressed metal, or alternatively cast in metal or molded in plastic. The final shape of the cage may exhibit very different appearances, particularly according to the material chosen in which to make it.

1. An elbow-shaped electric plug comprising first (7) and second (6) hollow cylindrical bodies fixed to one another and making an angle, one end (2) of the first body (7), closed by a stopper (3), being housed in one end (1) of the second body (6) so as to define a continuous passage between the free ends (8, 12) of the two bodies (6, 7), the first body (7) comprising a removable contact block (5, 11); the electric plug being characterized in that it further comprises a coaxial cylindrical cage (4) arranged in the first body (7) in such a way as to hold the removable contact block (5, 11) in position, the cage (4) further comprising a hollowing (23) formed on its longitudinal wall of a length shorter than the length of the cylindrical cage and arranged at the same side as the free end (12) of the second cylindrical body (6).

2. The electric plug as claimed in claim 1, characterized in that the width of the hollowing (23) extends over about 180° around the main axis of the cage (4).

3. The electric plug as claimed in claim 1, characterized in that the length of the hollowing (23) is slightly shorter than the length of the cage (4).

4. The electric plug as claimed in claim 1 comprising elastic means (18, 21) arranged towards the end of the cage (4) which is situated at the same end as the stopper (3) or between said end and the stopper (3), said means (3) being produced in such a way as to ensure elastic contact between the cage (4) and the stopper (3).

5. The electric plug as claimed in claim 4, characterized in that the cage (4) comprises an end that is rendered elastic (14) along the main axis of the cage (4).

6. The electric plug as claimed in claim 5, characterized in that the elastic end (14) is hollow, of conical shape, and has radial slots (19) extending from the vortex of the cone.

7. The electric plug as claimed in claim 5, characterized in that the elastic end (14) is solid and has a slot (20) made in a plane perpendicular to the main axis of the cage (4); that part of the cage (4) that is situated between the slot (20) and the stopper (3) having approximately the shape of a disk (21), said disk (21) comprising a protrusion (22) directed towards the outside of the cage (4), towards the stopper (3).

8. The electric plug as claimed in claim 5, characterized in that the cage (4) is of a length slightly longer than the space available, thereby causing the cage (4) to be compressed when the connector is closed by the stopper (3).

9. The electric plug as claimed in claim 4, characterized in that the elastic means are arranged between said end and the stopper (3).

10. The electric plug as claimed in claim 9, characterized in that the elastic means consist of a component made of elastomer, for example a seal of the O-ring type.

11. The electric plug as claimed in claim 9, characterized in that the elastic means consist of a spring.

12. The electric plug as claimed in claim 1, characterized in that the hollowing (23) is sufficiently large enough to give the cage (4) elasticity.

13. The electric plug as claimed in claim 1, characterized in that the end of the first body (7) which end is housed in the second body (6), is surrounded by a seal of the O-ring type (16).

14. The electric plug as claimed in claim 1, comprising a seal of the O-ring type (17) situated between the first body (7) and the second body (6), said seal (17) being arranged inside the second body (6) so as also to ensure optimum electrical contact between the bodies (6, 7).

15. A cylindrical cage (4) for an elbow-shaped electric plug as defined in claim 1, said cage (4) being designed to be arranged in the first body (7) of an elbow-shaped plug in such a way as to hold the removable contact block (5, 11) of the elbow-shaped plug in position; the cage (4) further comprising a hollowing (23) formed on its longitudinal wall of a length shorter than the length of the cylindrical cage and designed to be arranged on the same side as the free end (12) of the second cylindrical body (6) of the elbow-shaped plug.
